(19) United States
(12) Patent Application Publication
(10) Pub. No.: US 2015/0006301 A1
(43) Pub. Date: Jan. 1, 2015

(54) SYSTEM AND METHOD FOR TRANSFORMING PHOTO TAGS OF PRODUCTS INTO A LINKABLE ADVERTISEMENT OR PURCHASE PAGE

(71) Applicant: JOHN BENJAMIN MCMILLION, SAN DIEGO, CA (US)

(72) Inventor: JOHN BENJAMIN MCMILLION, SAN DIEGO, CA (US)

(21) Appl. No.: 13/931,884

(22) Filed: Jun. 29, 2013

(51) Int. Cl. G06Q 30/02; G06Q 50/00

(52) U.S. Cl. CPC G06Q 30/0277; G06Q 50/01
USPC 705/14.73

(57) ABSTRACT

A system includes a plurality of servers to process and serve a social web application and advertising platform. The platform is capable of transforming tags of products in identifiable regions of a socially shared photo into a linkable advertisement and/or hyperlink to a purchase page for the products. Transforming the shared photo itself into a multi-faceted advertisement, creates direct relevance, desire, works within the confines of screen real estate limitations, saves manual research and communication and provides a direct path to complete the purchase.

### CROSS-REFERENCE TO RELATED APPLICATION

This application claims the benefit of U.S. Provisional App No. 61/666,967 filed Jul. 2, 2012.

### BACKGROUND OF THE INVENTION

Photos shared on social networks typically provide the ability to like or comment on a photo, but do not extend the like action into a direct purchase. Meanwhile, a socially shared photo of, for example, outfits your friends are wearing, a room your friends decorated, or a recipe your friends baked, is often enticing and highly relevant, but finding out where to purchase any of the specific items in these outfits, rooms, or recipes requires manual research and additional communication.

Presently, social networks which are supported by advertising, push a “related” online advertisement campaign to the whitespace area surrounding the content. In all viewports and devices, “related” online advertising campaigns, are less relevant and enticing, than products friends or idols may be using or wearing in shared photos. Such known advertising, may, for example, display an advertisement for a clothing company while a user desires the shirt worn by their friend, a hardware store when a user may want the lamp seen in a photo of a room a friend just decorated, or a grocery store when a user really wants the specific ingredients to complete a recipe. These advertisements do not provide a hyperlink directly to specific items for sale to quickly complete a purchase.

Furthermore, in mobile viewports, with smaller screen real estate, there is little if any room for placing advertisements to the side of content.

Transforming the photo itself into a multi-faceted advertisement, creates direct relevance, desire, works within the confines of screen real estate limitations, saves manual research, and provides a direct path to complete the purchase.

### SUMMARY OF THE INVENTION

The present invention transforms a photo shared online into the advertisement itself, and further provides the ability to complete a direct purchase of, by hyperlink, one or more items seen and tagged in the photo. When pieces in the photo are text-tagged with item and manufacturer identifiers, the system can transform the text tag into an advertisement with more information including a hyperlink to a purchase website. This solves the manual research and communication problem, and/or transforming the text tag into a hyperlink to purchase online.

### BRIEF DESCRIPTION OF THE FIGURES

FIG. 1 illustrates a schematic of an exemplary configuration of hardware components according to an embodiment of the present invention.

FIG. 2 illustrates a first exemplary graphical user interface in accordance with the present invention.

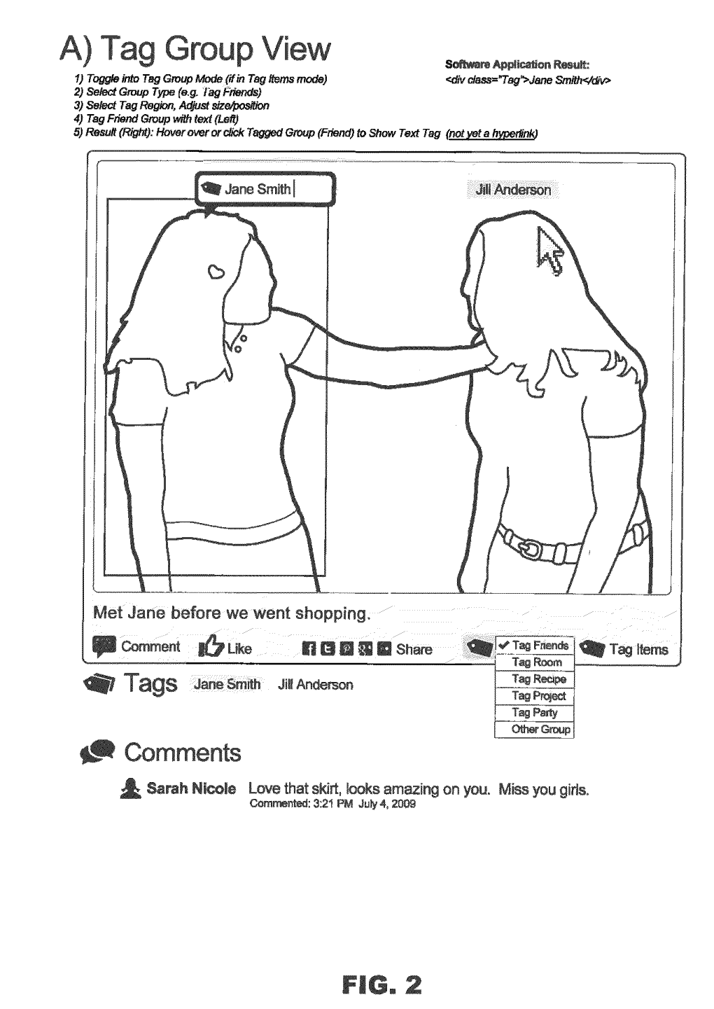

FIG. 3 illustrates a second exemplary graphical user interface in accordance with the present invention.

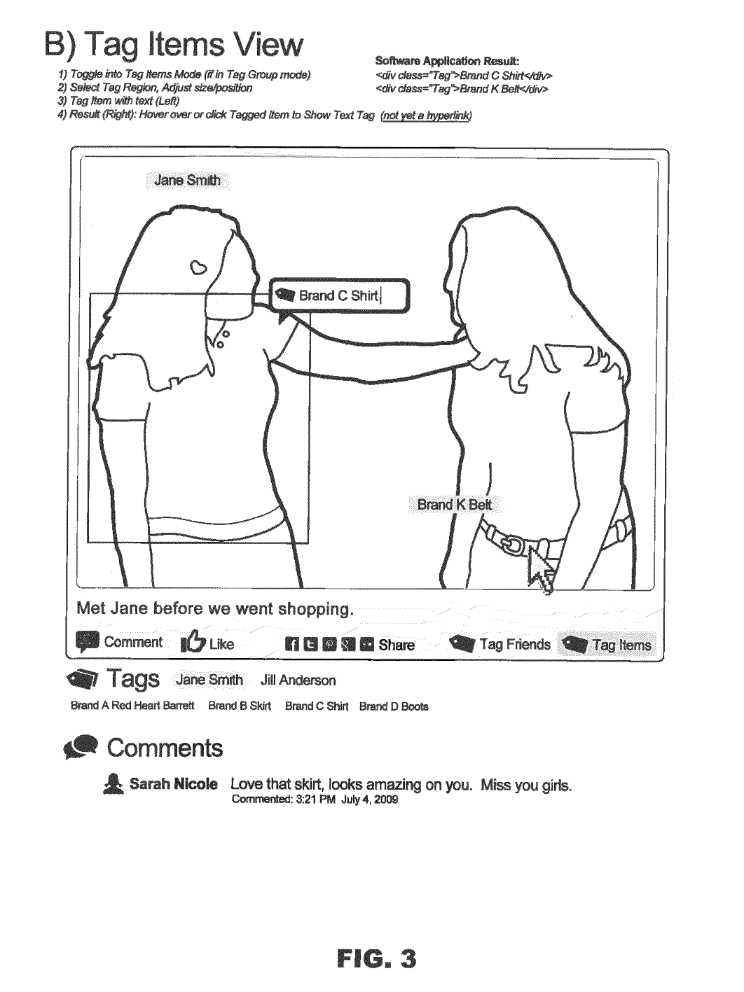

FIG. 4 illustrates a schematic of steps of a process in accordance with an exemplary embodiment of the present invention.

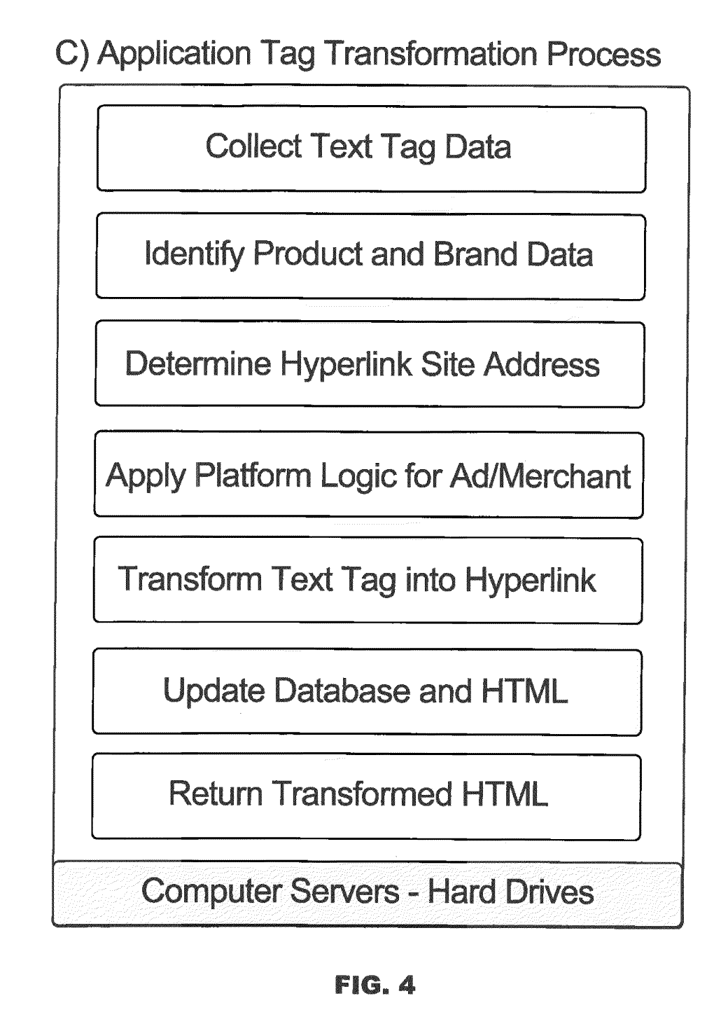

FIG. 5 illustrates a third exemplary graphical user interface in accordance with the present invention.

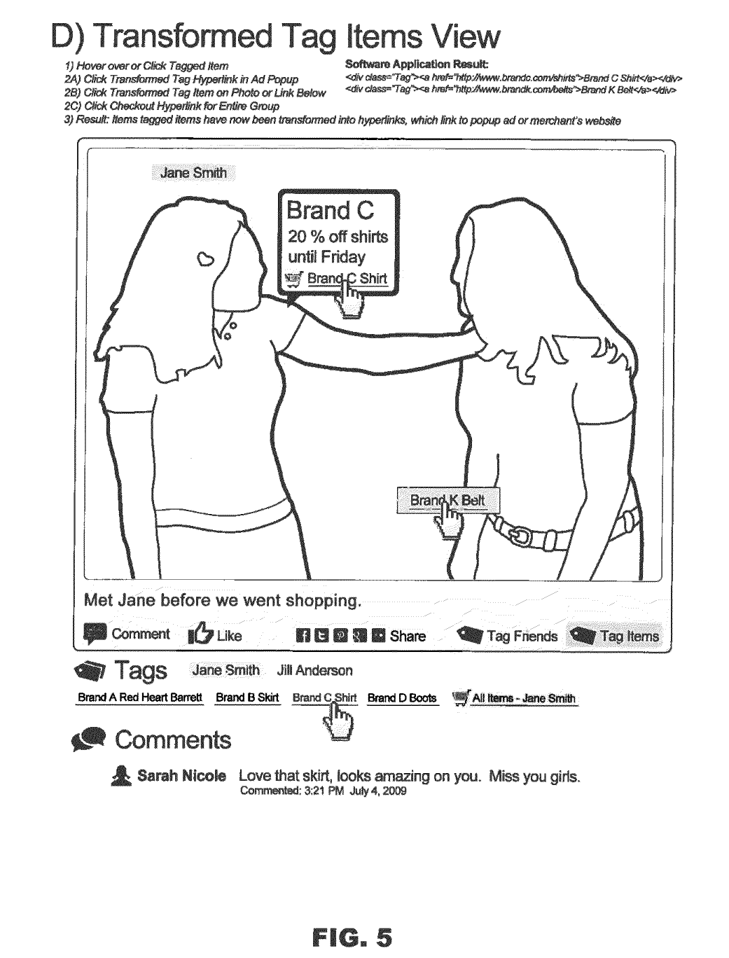

FIG. 6 illustrates a fourth exemplary graphical user interface in accordance with the present invention.

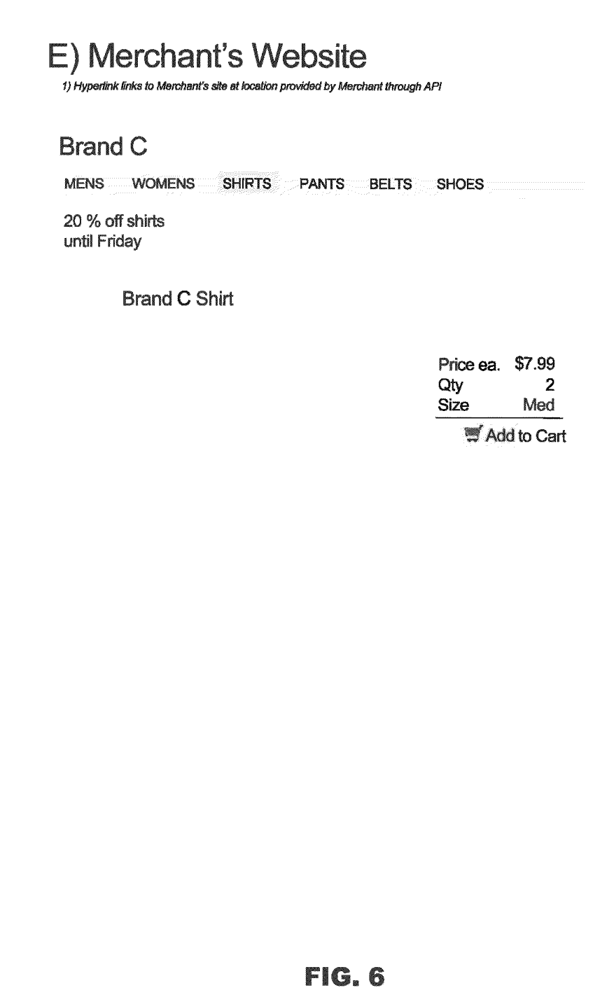

### DETAILED DESCRIPTION OF THE INVENTION

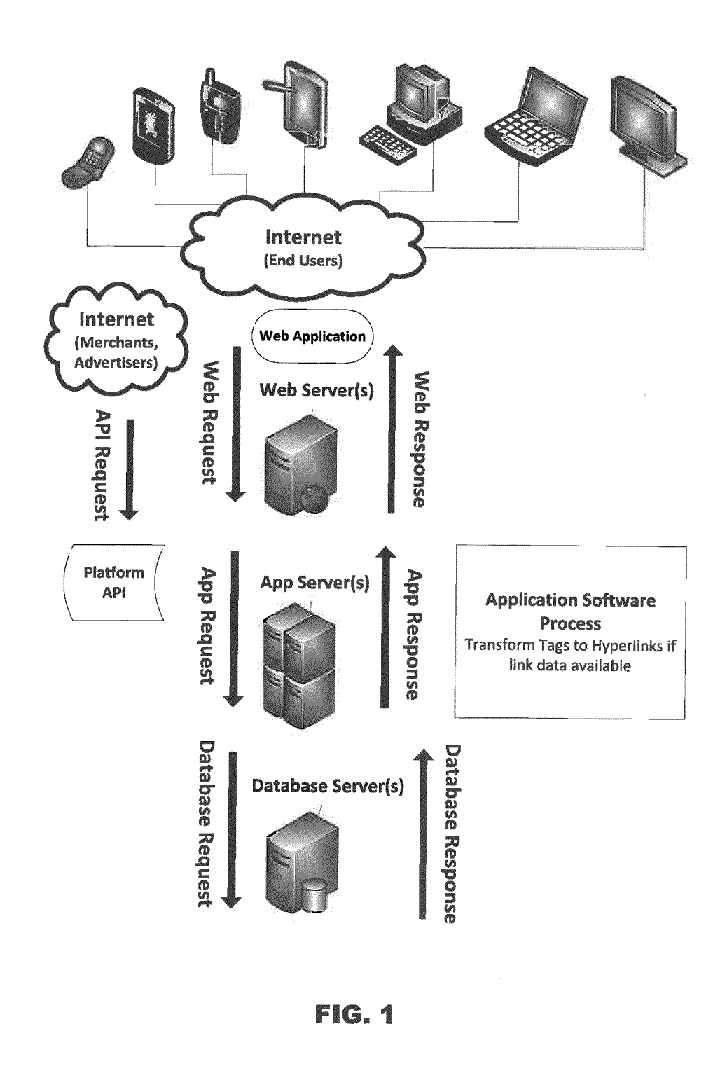

A system and method in accordance with the present invention may be provided through implementation on a network including a number of database, application and web servers accessible directly or indirectly by end users through use of mobile phones, tablet computers, laptop computers, desktop computers, etc as depicted in FIG. 1. The one or more servers store social network photo content, user preference and product data.

In particular, servers serve a social network. Through their computer or mobile devices, end user upload and tag products in photos shared through the social network. Vendors and advertisers use the platform software to update product data tagged in shared end user photos. The servers run the process according to instructions provided on a computer-readable medium in the form of computer-readable program code. This process includes applying user preference and product data to transform text tags into hyperlinks to advertisements or to directly purchase products viewable within the shared end user photos.

According to a preferred embodiment of a method for providing hyperlink tags to end user shared photos within a social network, one or more users first upload photos onto a social network web application for sharing. After upload, products viewable in the uploaded photos may be tagged by the user or automatically using text. For example, the user may tag a shirt they are wearing in the photo with the brand name and the item type shirt or V-Neck. In some embodiments, optional attributes for the product may be selectable, such as size, color, price, their own link, where they found it, etc. Users viewing photos, may also submit their personal preferences such as they are a size 9, to add additional transformational detail for the resulting purchase link.

For each product text tag in a photo, the process of the present invention transforms the text tag into a hyperlink if the product has corresponding advertisement or vendor website to link to in a product database. Using a database of product data, the user or system searches and matches the user-submitted text tags of products with the brand/merchant submitted product data and site links and establishes that data relationship. According to a transformation process, the system collects text tag data, identifies product and brand data based upon user input and/or vender information within a database, determines a site address for a hyperlink to the product or products, applies platform logic for the advertiser, transforms the text tag into the hyperlink, updates the database to establish the relationship between the user text tag, a hyperlink and html and returns the transformed html to the uniform resource locator which references the source of the social networking website upon.

Web application servers exploit user-provided tag information to render a hyperlink in place of a text tag. For example, the text only tag “Green Gap™ V-Neck” is transformed into a hyperlink for either an advertisement like “20% off all Gap V-Necks”, and/or a hyperlink to a vendor's website like http://www.gap.com/products/women/vneckshirt or http://www.amazon.com/products/123456, potentially appended with querystring attributes such as ?size=9&color=green.

After transformation of the text tags, when a user clicks each tagged region for each product seen in the photo, a larger window displays with more details which may include an advertisement or hyperlink, and/or the text tag “Green Gap™ V-Neck” is now a clickable hyperlink, that takes the user to the vendor's website.

Vendors or advertisers use a platform API to build up product data, bid on placements and priority for the transformations and to feed product data needed for the web application to correlate their product with either an advertisement and/or a site link to complete the purchase. This may also be accomplished through administrator pages on social media network site. The vendors are also able to view current bids, set advertising campaign length, set campaign budget capacities, view click/impression traffic, etc.

As with many known social networks, users of the present system are able to comment on photos, tag friends and/or group friends “family, work colleagues” in lists for sharing, group photos into collections, set visibility/privacy of shared photos, etc.

Additional, optional functions may include a toggle between tagging friends in photos and tagging the products in photos, style filters to make photos look appealing, or sharing of tagged/linked photos on other social networks.

In some embodiments, when the system forms the relationship between product text tag and product link, a process will determine which link to render based on a prioritization procedure. For example, the first priority may be a highest bid or highest revenue calculated from active advertisement campaign or merchant. Popover advertisement with link and additional text has higher revenue than basic link. A second-level priority may be an affiliate referral link which generally generates less revenue than advertisement bid. A third-level priority may be a user-submitted link which generates no revenue but may cause word-of-mouth advertising for the product.

In some embodiments, the web application may allow purchasing directly within the web application, without the need to hyperlink out to an external website. In such embodiments, upon clicking a clickable button for of the desired object depicted in the photo a user may add the object to a cart for purchase during checkout.

In some embodiments, users will be able to like individual pieces/products/items tagged/linked within photos and/or the photo itself.

In some embodiments, a social media network home page associated with the social network will display vertical lists of photos ranked by most liked, grouped in lanes by categories such as outfits, recipes, rooms, etc.

The user experience, software, and platform API are usable with websites other than the social network platform disclosed.

Additionally, data aggregated from use activity in the web application may be provided to advertisers for analysis.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed is:

1. A method for product promotion by hyperlink tags, comprising:
uploading a digital photo to a remote database server for association with a user profile of a virtual social network;
tagging one or more products depicted in the digital photo with a text tag;
transforming the text tags to hyperlink tags for displaying advertisements for each of the one or more products and for displaying a hyperlink to a product purchase page for each product;
associating a plurality of attributes with the one or more products and respective hyperlink tags;
displaying the advertisements and one or more of the plurality of attributes upon selection of a hyperlink tag by a first type of selection; and
displaying the product purchase page upon selection of the hyperlink by a second type of selection.
